(19) United States
(12) Patent Application Publication
(10) Pub. No.: US 2026/0099346 A1
(43) Pub. Date: Apr. 9, 2026

(54) SPEED ENHANCEMENT SYSTEM AND METHOD FOR COMPUTER MATHMATICS CALCULATIONS

(71) Applicant: Hayan Software Accelerator LLC, Palm Beach, FL (US)

(72) Inventor: Nitin Vala, Jupiter, FL (US)

(21) Appl. No.: 19/325,433

(22) Filed: Sep. 10, 2025

Related U.S. Application Data
(60) Provisional application No. 63/693,028, filed on Sep. 10, 2024.
(60) Provisional application No. 63/700,123, filed on Sep. 27, 2024.

(51) Int. Cl. G06F 9/455; G06F 9/54

(52) U.S. Cl. CPC G06F 9/45516; G06F 9/544

(57) ABSTRACT

The present invention provides a method and system for constructing computer software to operate with a specific CPU chip architecture to improve the performance speed of the computer and software. By coding the software to operate with a specific CPU, the software can be caused to send the calculations through the CPU or GPU in a manner which results in a much faster result than would normally occur without the present system and method. The present system and method also better utilizes the full capacity of the CPU or GPU to make calculations, and increases the security of the computer for data transfers.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/693,028, entitled “Speed Enhancement System and Method for Computer Mathematics Calculations”, filed Sep. 10, 2024, and U.S. Provisional Patent Application No. 63/700,123, entitled “Speed Enhancement System and Method for Computer Mathematics Calculations”, filed Sep. 27, 2024. The contents of the above referenced application are incorporated herein by reference in their entirety.

### FIELD OF THE INVENTION

The present invention relates generally to computers, and more specifically, to a method of causing a computer to make mathematical calculations faster than without the speed enhancement method.

### BACKGROUND OF THE INVENTION

Everyone has sat down at a computer, turned it on, and tried to open a software program. As we wait for the software to open, we often contemplate a plan for causing the computer to perform the requested task faster by clearing cache or eliminating unneeded software, etc. As time has passed, computers have gotten faster and thus are capable of performing the old tasks much faster than an older machine; however, the software and the number of tasks required to complete the requested task have also multiplied as fast, or faster, than the capabilities of the machines.

This is especially true in business software, which often tasks computers to their maximum capabilities for extended times. For example, market predictions, and the like, often require a computer to run for hours to calculate a single prediction based upon market inputs. Thus, it is still impossible, or nearly so, to run as many predictions or scenarios on a system to provide adequate data to banks and investors alike. Thus, many businesses that utilize predictive analysis of data, particularly data that changes daily, require multiple systems or simply make some of the calculations manually.

Computers understand what tasks we want them to do based upon our input to the computer with mouse clicks, keyboard entry, writing on a tablet, issuing voice commands, or using a joystick. These instructions typically referred to as “inputs” tell the software, and thus the computer, to do something. The exact instructions for completing the input are written by a programmer and processed by the central processing unit (CPU), which is part of the computer's hardware. The CPU completes the requested task and stores the results in the computer's memory. In order to complete the task, the software often changes the task from something that we understand in words to a logical or mathematical operation for the CPU to perform, the result is then stored or displayed. Thus, typical improvements in mathematical calculation speed are governed by increasing processing speed or increasing available memory for the CPU to utilize in making calculations.

Therefore, what is needed in the art is a software that provides a system and method for directing the software calculations through the CPU or GPU chip in a specific manner to better utilize the pathways provided in the chip(s). The method and system should be unique to different types of chips to improve the performance of different chip architectures. The system and method should be employed at the software code level to construct new software code or reengineer pre-existing code to provide the increased speed.

### SUMMARY OF THE INVENTION

The present invention provides a method and system for constructing computer software to operate with a specific CPU chip architecture to improve the performance speed of the computer and software. By coding the software to operate with a specific CPU, the software can be caused to send the calculations through the CPU in a manner which results in a much faster result than would normally occur without the present system and method. The present system and method also better utilize the full capacity of the CPU to make calculations and increase the security of the computer for data transfers.
1 Accordingly, it is an objective of the present invention to provide a system and method for improving the number of mathematical calculations performed by a CPU or GPU in a given time.
1 It is a further objective of the present invention to provide a system and method for dividing tasks to be completed by a CPU or GPU based upon the CPU or GPU architecture to improve processing speed.
1 It is yet another objective of the present invention to provide a system and method of increasing the number of mathematical calculations provided by a CPU or GPU in a given time.
1 It is a still further objective of the present invention to provide a system and method of increasing CPU or GPU mathematics processing that is scalable.
1 Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1A illustrates a parallel reduction method for increasing mathematics processing in a computer;

FIG. 1B further illustrates a parallel reduction method for increasing mathematics processing in a computer;

FIG. 1C illustrates global synchronization of computer processing;

FIG. 1D discusses a kernel decomposition method for increasing CPU and GPU processing in a computer;

FIG. 2A illustrates the kernel decomposition method for increasing CPU and GPU processing in a computer;

FIG. 2B illustrates the kernel decomposition method for increasing CPU and GPU processing in a computer;

FIG. 3A illustrates interleaved addressing code;

FIG. 3B illustrates parallel reduction with interleaved addressing;

FIG. 3C illustrates parallel reduction with interleaved addressing;

FIG. 3D illustrates computer performance utilizing parallel reduction with interleaved addressing;

FIG. 3E illustrates 4M element reduction;

FIG. 3F illustrates an example of interleaved addressing;

FIG. 3G illustrates interleaved addressing with non-divergent branching and interleaved addressing with memory bank conflicts;

FIG. 3H illustrates interleaved addressing with divergent branching and interleaved addressing with memory bank conflicts;

FIG. 3I illustrates interleaved addressing with divergent branching and interleaved addressing with memory bank conflicts;

FIG. 4A illustrates parallel reduction with sequential addressing;

FIG. 4B illustrates code for causing the CPU or GPU to perform parallel reduction with sequential addressing;

FIG. 4C illustrates code for causing the CPU or GPU to perform parallel reduction with reversed loop and thread ID-based indexing;

FIG. 5 illustrates performance data utilizing the interleaved addressing for 4M element reduction;

FIG. 6A illustrates code that results in idle threads;

FIG. 6B illustrates how to alter code to reduce idle threads;

FIG. 6C illustrates performance data when idle threads are reduced;

FIG. 6D illustrates performance data relating to 4M element reduction;

FIG. 7A illustrates instruction bottlenecks;

FIG. 7B illustrates unrolling warps;

FIG. 7C illustrates code for unrolling warps;

FIG. 7D illustrates performance data for unrolling warps;

FIG. 7E illustrates performance data for unrolling warps for 4M element reduction;

FIG. 7F illustrates complete unrolling of warps;

FIG. 7G illustrates complete unrolling of warps utilizing templates;

FIG. 7H illustrates code for complete unrolling of warps;

FIG. 7I illustrates code for complete unrolling of warps;

FIG. 7J illustrates code for invoking template kernels;

FIG. 7K illustrates performance data when the warps are unrolled for 4M element reduction;

FIG. 8A illustrates code for parallel reduction;

FIG. 8B illustrates costs associated with the programming speed ups;

FIG. 8C illustrates algorithm cascading;

FIG. 8D illustrates code for multiple adds per thread;

FIG. 8E illustrates code for multiple adds per thread;

FIG. 8F illustrates performance data for multiple adds per thread;

FIG. 8G illustrates performance data for multiple adds per thread for 4M element reduction;

FIG. 9A illustrates code for the final optimized kernel;

FIG. 9B illustrates code for the final optimized kernel;

FIG. 10 illustrates performance comparison data for the methods utilized herein for speeding up processing speeds;

FIG. 11 illustrates a processor comparison for providing guidance as to which reductions to utilize; and

FIG. 12 illustrates computer hardware and data flow.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

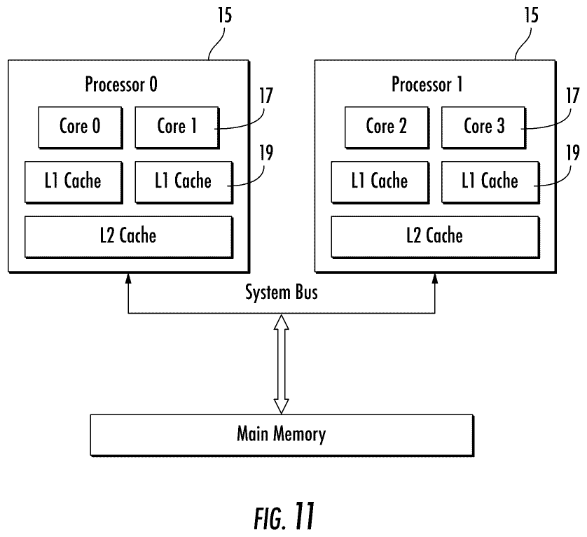

Now referring generally to the figures. The present invention provides a method and system for constructing computer software 100 to operate with a specific CPU chip architecture to improve the performance speed of the computer and software. By coding the software to operate with a specific CPU, the software can be caused to send the calculations through the CPU in a manner which results in a much faster result than would normally occur without the present system and method. Computers typically include a monitor for viewing typing and results from processing data, a keyboard for data entry, a mouse or other pointer for navigating software and graphics, memory in the form of hard memory, temporary memory, virtual memory, random access memory, and at least one processor. Programmers understand that every CPU, graphics processing unit (GPU), motherboard, random access memory (RAM), and hard drive operate at different speeds and at different electrical frequencies. The present system and method analyzes these different computer components and modifies the software to improve the calculation speed of the system as it is configured. The system initially considers the CPU 15 (see FIG. 11) by analyzing the type of CPU. Is it an Intel CPU or an AMD CPU? What is the total number of cores 17 in the respective CPU? What is the total number of threads in the respective CPU? What is the maximum turbo frequency of the CPU? What is the processor base frequency, and does the CPU have CPU cache 19? Another consideration for maximizing calculation speed is Ultra Path Interconnect speed (UPI). UPI is a low-latency coherent interconnect for scalable multiprocessor systems with a shared address space. It uses a directory based home snoop coherency protocol with a transfer speed of up to 10.4 giga transfers per second (GTIs). Supporting processors typically have two or three UPI links. Total distributed power, for example, 350 Watts. Max RAM size of the computer or system. The maximum number of memory channels: the maximum memory bandwidth is the maximum rate at which data can be read from or stored into a semiconductor memory by the processor (in GB/s). The theoretical maximum memory bandwidth for Intel Core X-Series Processors can be calculated by multiplying the memory frequency (one half since double data rate×2), multiplied by the number of the bytes of width, and multiplied by the number of the channels supported for the processor. For example: For DDR4 2933, the memory supported in some core-x series is (1466.67×2)×8 ( #of bytes of width)×4 ( #of channels)=93,866.88 local memory bandwidth (MBl), or 94 GB/s. What is the maximum CPU operating temperature? Is there a deep learning Boost on CPU available? Are there high priority cores available? What is the frequency of the high priority cores? What is the number of low priority cores available in the processor? What is the low priority core frequency? Another consideration for the present system and method is Resource Director Technology (RDT). RDT brings new levels of visibility and control over how shared resources, such as last-level cache (LLC) and memory bandwidth are used by applications, virtual machines (VMs) and containers. Speed Shift Technology: Speed Shift Technology uses hardware-controlled P-states to deliver dramatically quicker responsiveness with single-threaded, transient (short duration) workloads, such as web browsing, by allowing the processor to more quickly select its best operating frequency and voltage for optimal performance and power efficiency. Turbo Boost Technology: Turbo Boost Technology dynamically increases the processor's frequency as needed by taking advantage of thermal and power headroom to give you a burst of speed when you need it. Transactional Synchronization Extensions are a set of instructions that add hardware transactional memory support to improve performance of multi-threaded software.

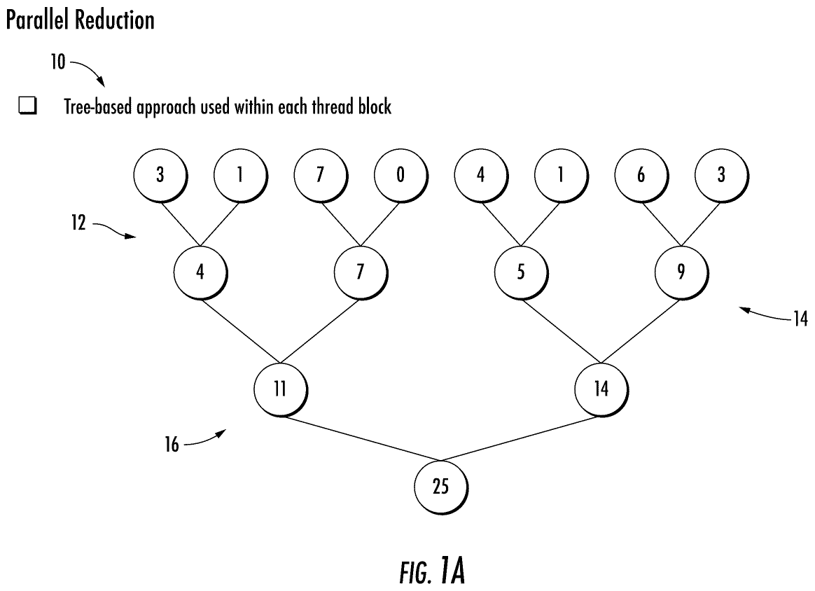

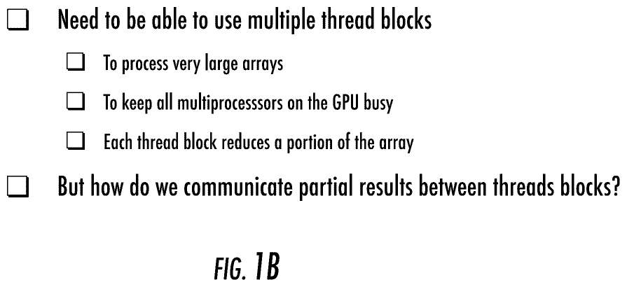

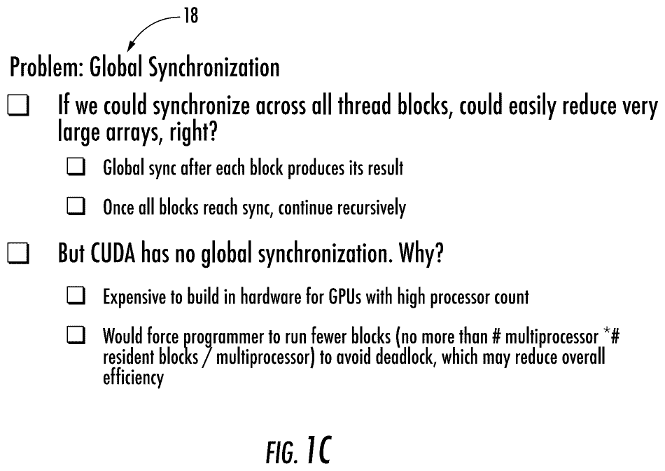

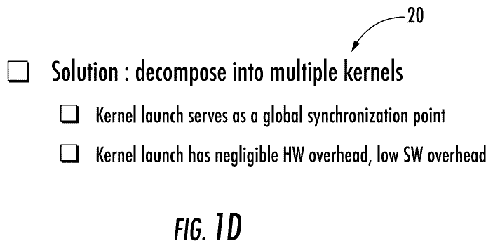

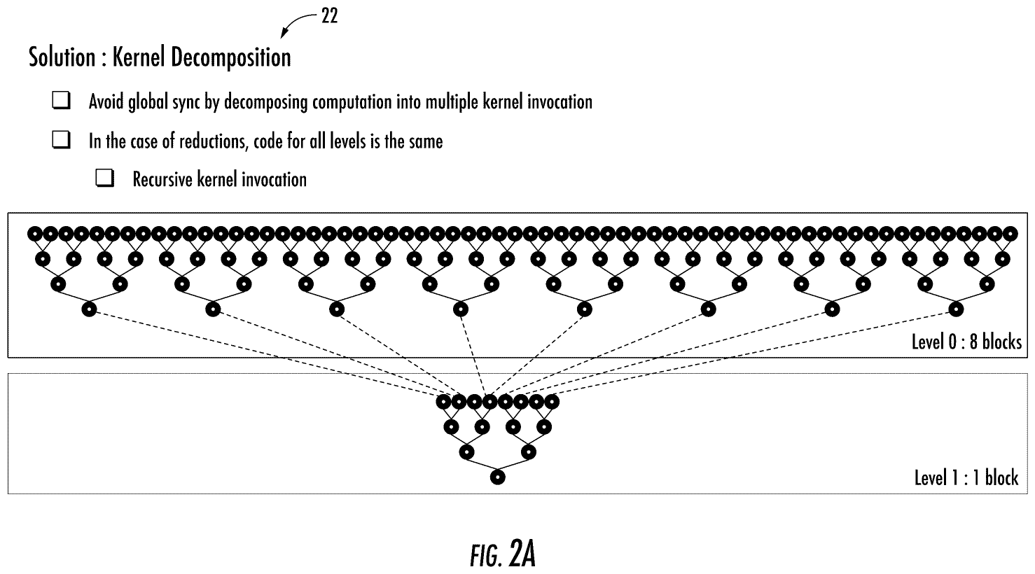

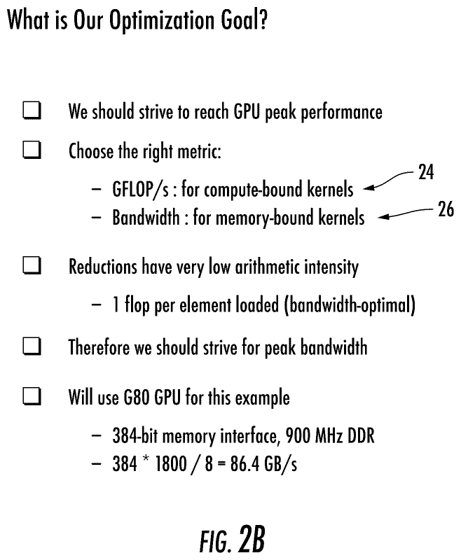

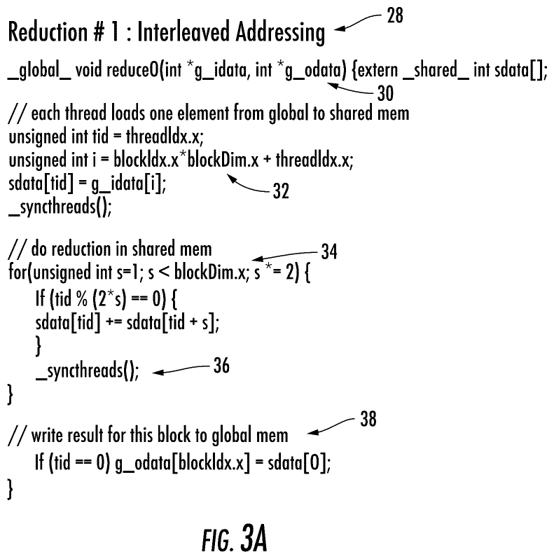

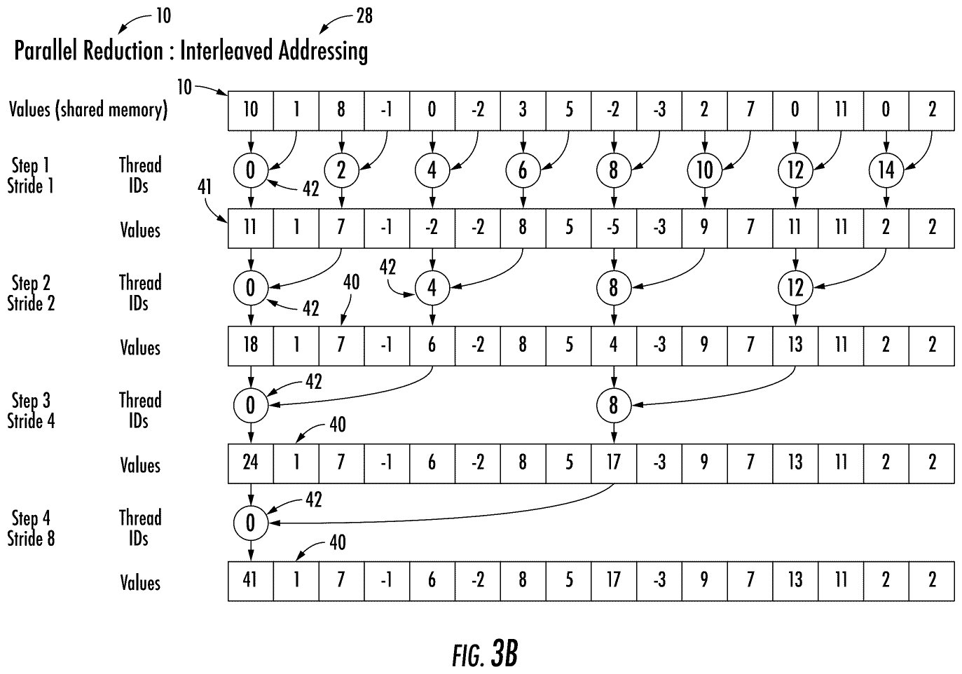

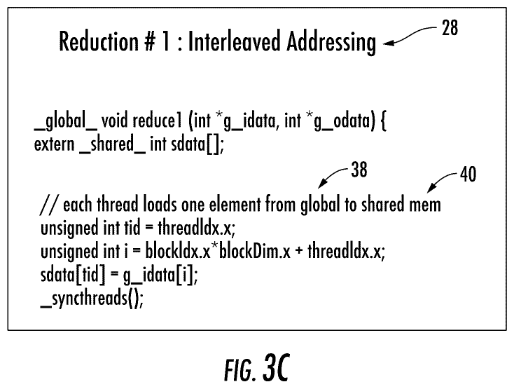

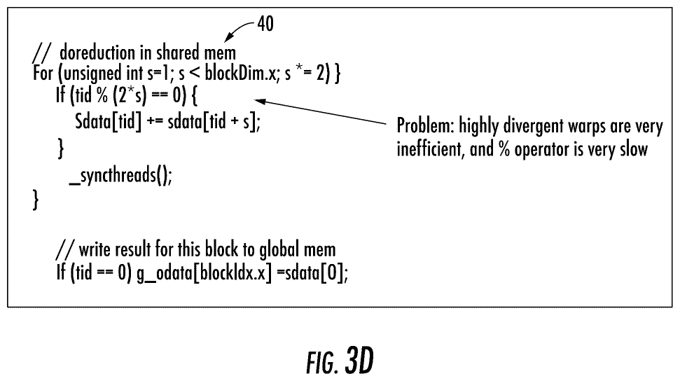

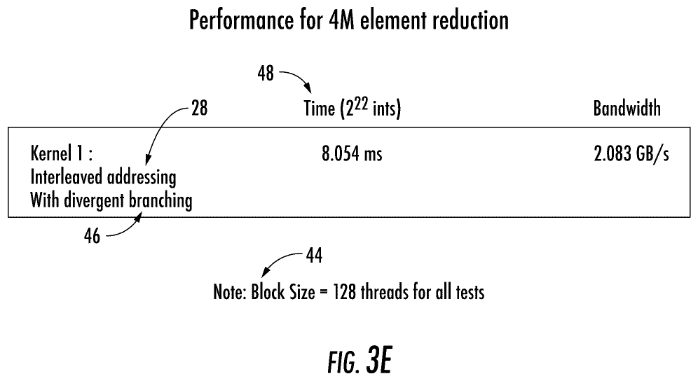

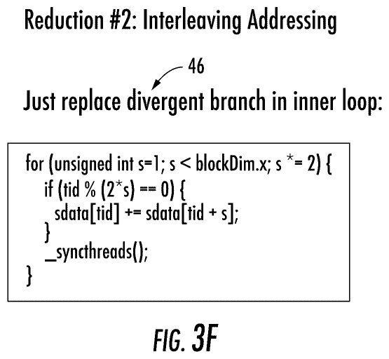

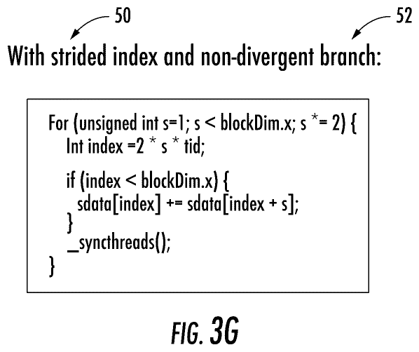

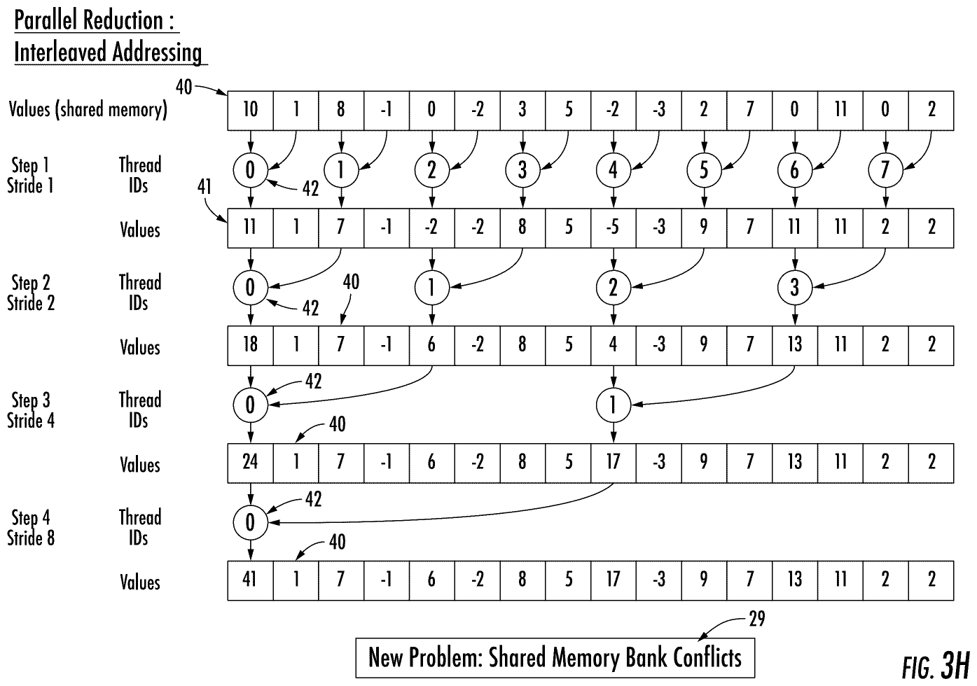

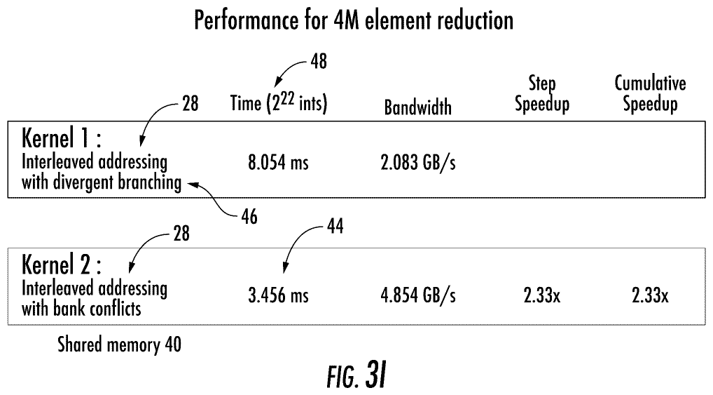

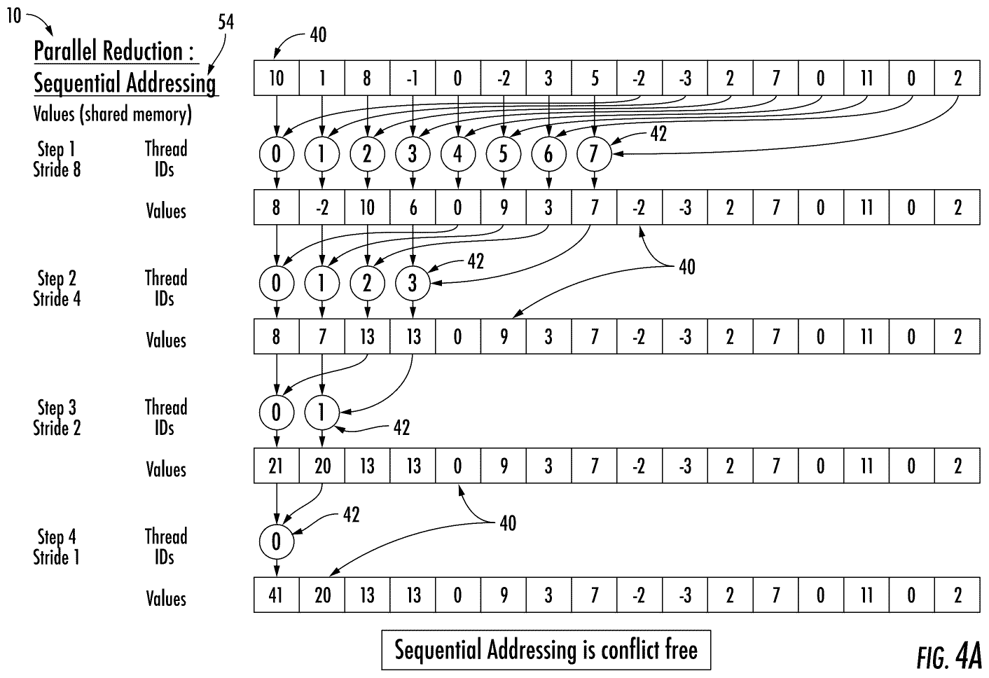

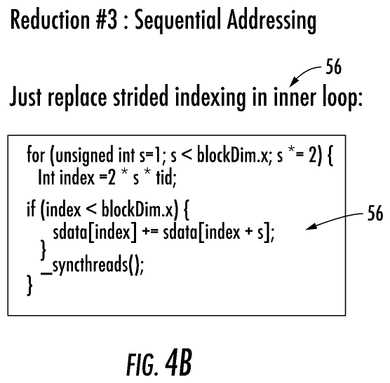

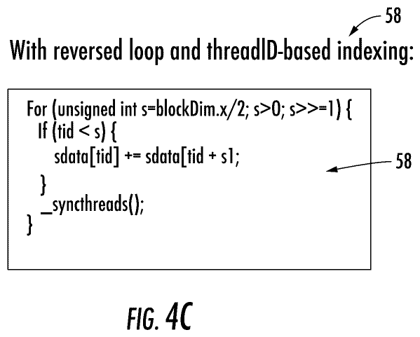

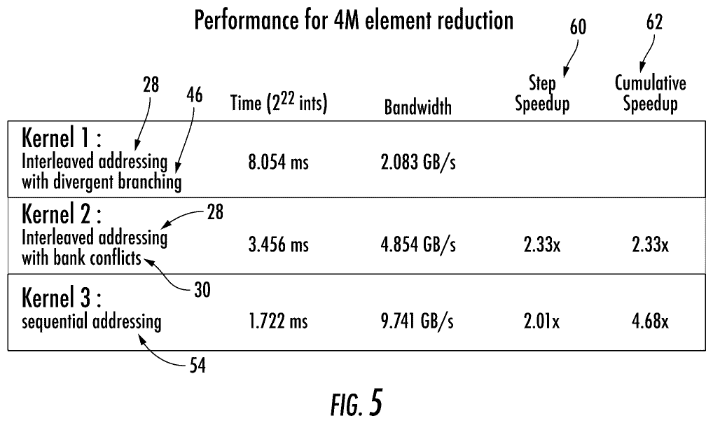

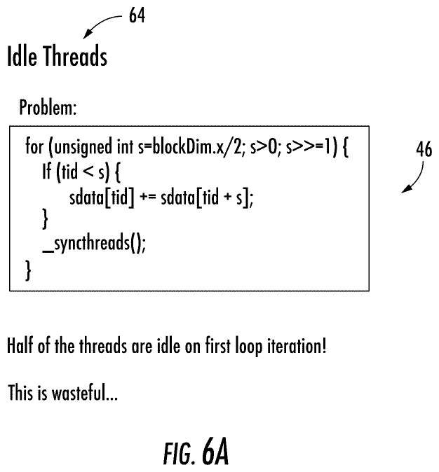

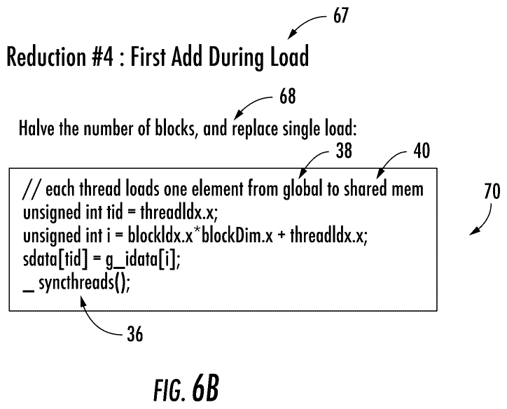

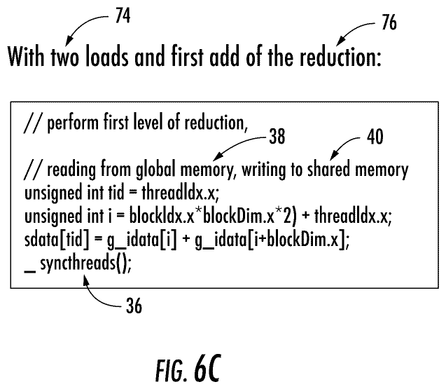

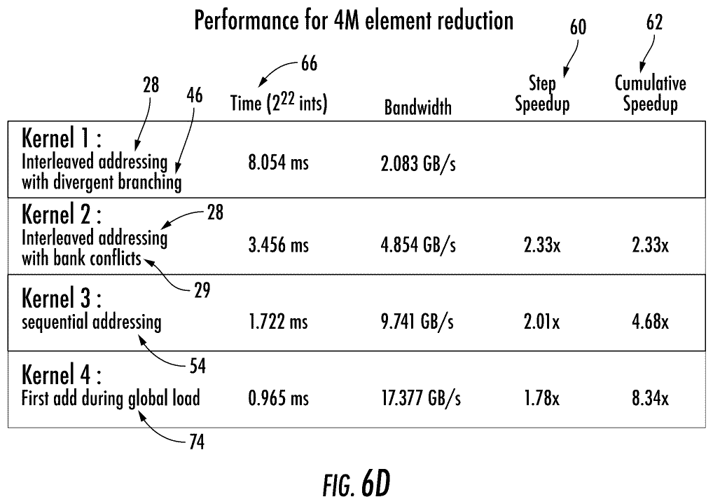

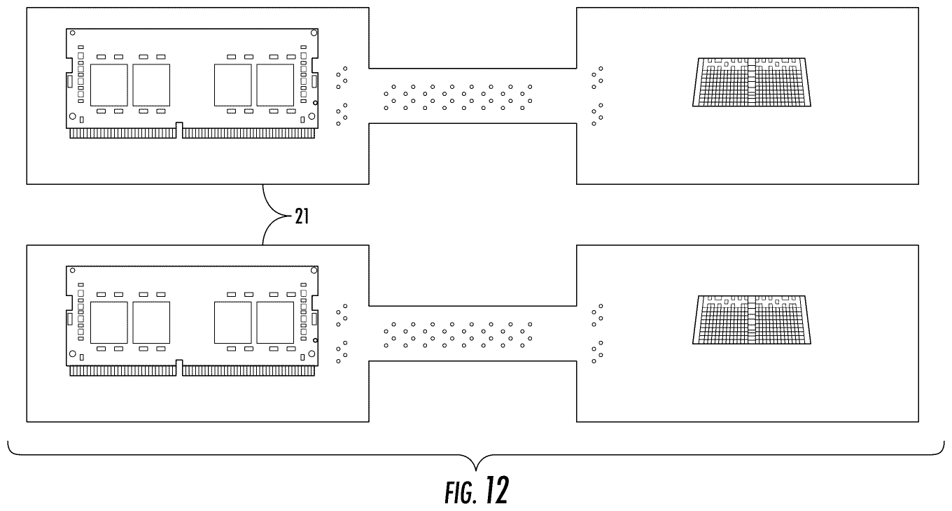

Referring generally to the figures, and more specifically to FIGS. 1-10, the method of computing mathematics in a computer using parallel reduction 10 is illustrated. Parallel reduction 10 is a tree-based 12 approach used within each thread block 14. However, multiple thread blocks 14 must be used to process large arrays 16. A problem currently exists in this example, as there is not currently a way to communicate partial results between the different thread blocks 14. Therefore, a global synchronization 18 of the partial results only occurs after processing of each thread block 14. This reduces efficiency of the software and may deadlock the computer if the number of resident blocks in the processor is exceeded. One solution to this issue is to decompose the data into multiple kernels 20. The kernel launch serves as a global synchronization point. The kernel launch has negligible hardware (HW) overhead and low software (SW) overhead. By decomposing the computation into multiple kernel 20 invocations 22, a global synchronization can be avoided and the calculations are significantly reduced, and recursive kernel invocation can be utilized. When striving to reach GPU 21 (see FIG. 12) performance, a proper metric for the kernels should be chosen. In the present system and method, GFLOP/s are utilized for compute-bound kernels 24 and Bandwidth is utilized for memory-bound kernels 26. In this manner, the program can better utilize bandwidth for calculations. For example, a G80GPU having a 384 bit memory interface running at 900 MHz DDR is calculated as 384*1800/8=86.4 GB/s. Also useful in the present method and system is interleaved addressing 28 (FIG. 3A). An interleaved addressing command line example 30 is illustrated. In this example, each thread loads one element from global to shared memory 32. A reduction in shared memory 34 is provided and the threads are synced before the result is written to global memory 38. FIG. 3B provides an example of parallel reduction 10 using interleaved addressing 28. As illustrated, values of shared memory 40 are identified by thread IDs as they are processed. In this example, the reduction in required computations is clearly illustrated. FIG. 3C provides an alternative method of reduction in shared memory 34 using interleaved addressing 28. In this example, each thread loads one element from global memory 38 to shared memory 40. The reduction is completed in the shared memory, and the result is written to global memory 38. An example of performance speed for element reduction using interleaved reduction 28 of FIG. 3C is illustrated in FIGS. 3D-3E. In this example, a block 44 having a size of 128 threads is processed with interleaved addressing 28 and divergent branching 46, resulting in a time 48 of 8.054 milliseconds (ms) and a bandwidth of 2.083 GB/s. FIG. 3G provides an example where the divergent branch 46 is replaced in the inner loop with a strided index 50 and non-divergent branch 52. While functional, this results in a new problem, causing shared memory 40 conflicts. FIG. 3I illustrates the performance of the interleaved addressing 28 with divergent branching 46 compared to the interleaved addressing 28 having shared memory 40 conflicts 29. As illustrated, the time is much faster 3.456 ms (milliseconds) compared to 8.054 ms, providing a substantial increase in speed. FIGS. 4A-4C illustrate parallel reduction 10 with sequential addressing 54, which provides a result without the conflicts seen in the prior examples. The sequential addressing 54 is accomplished by replacing the strided indexing in the inner loop 56. This is also possible with reversed loop and thread ID based indexing 58. FIG. 5 illustrates a performance comparison between interleaved addressing 28 with divergent branching 46, interleaved addressing 28 with shared memory bank conflicts 30, and sequential addressing 54. In this comparison, the step speedup 60 and the cumulative speedup 62 become more evident as the present method is utilized. FIG. 6A illustrates yet an additional area, e.g. idle threads 64, where the present method is useful for improving the speed of computer calculations 66. In general, about half of the thread blocks 14 are idle on a first loop iteration. As illustrated on FIG. 6B, the threads are typically halved and replaced with a single load 68 using a single load command 70 before the thread blocks 14 are synchronized. To provide added speed, the thread blocks 14 are loaded as two loads 74 and a first add of the reduction 76 reading from global memory for writing to shared memory to synchronize the threads 36. As shown on FIG. 6C, the speed improvement of using two loads 74 and a first add of the reduction 76 before synchronization is illustrated as Kernel 4, providing a substantial speed increase over Kernel 1 representing interleaved addressing 28 with divergent branching 46. The first add of the reduction 76 is also much faster than Kernel 2 representing interleaved addressing 28 with shared memory bank conflicts 29. The first add of reduction is also faster than sequential addressing 54 as represented by Kernel 3.

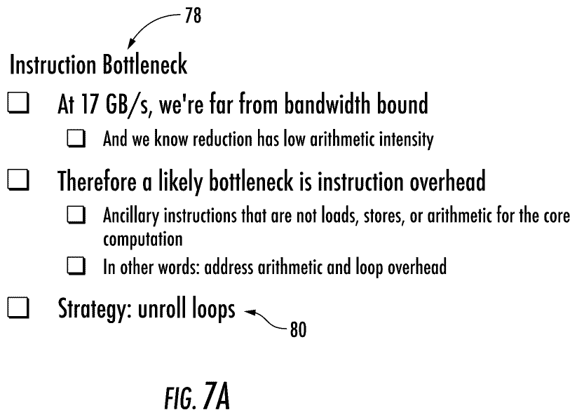

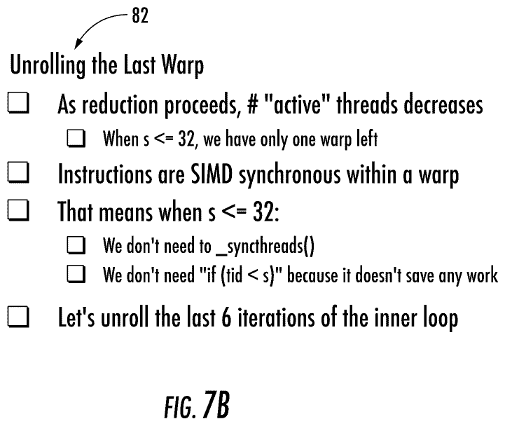

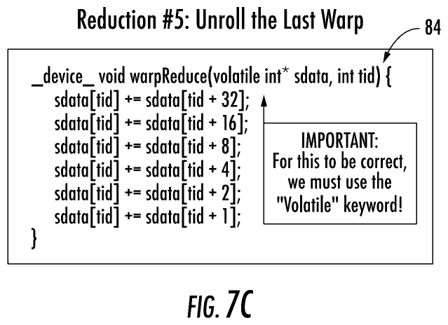

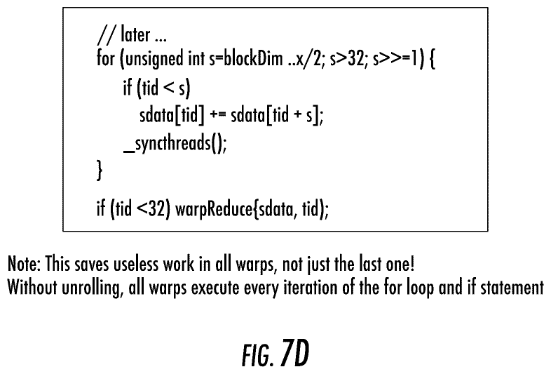

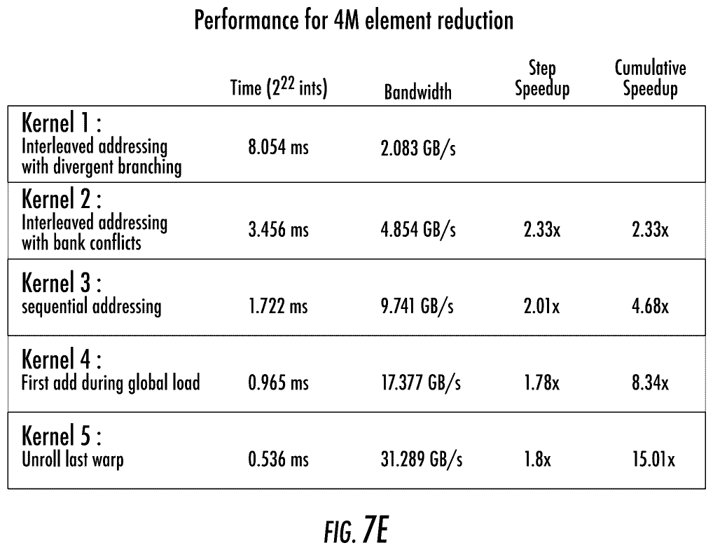

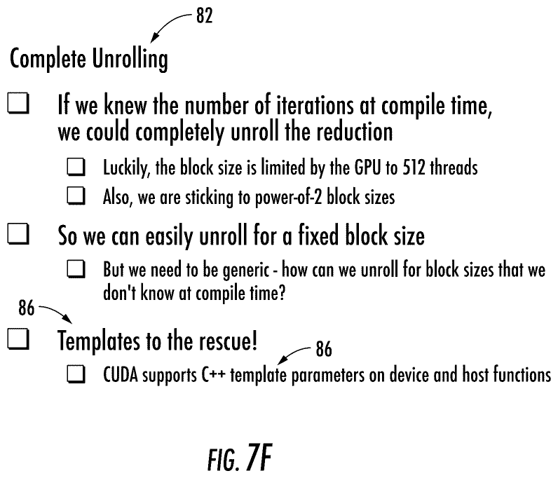

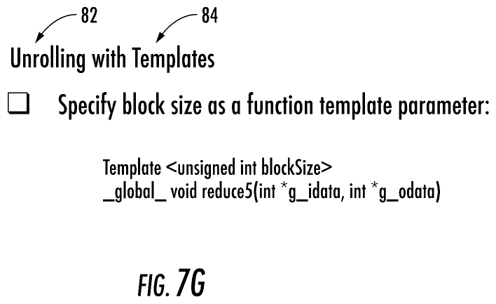

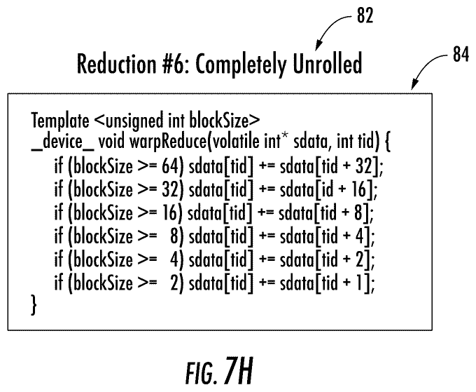

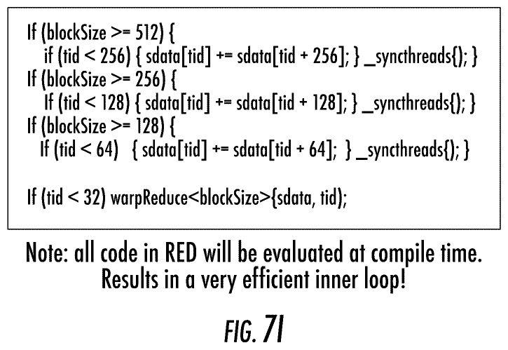

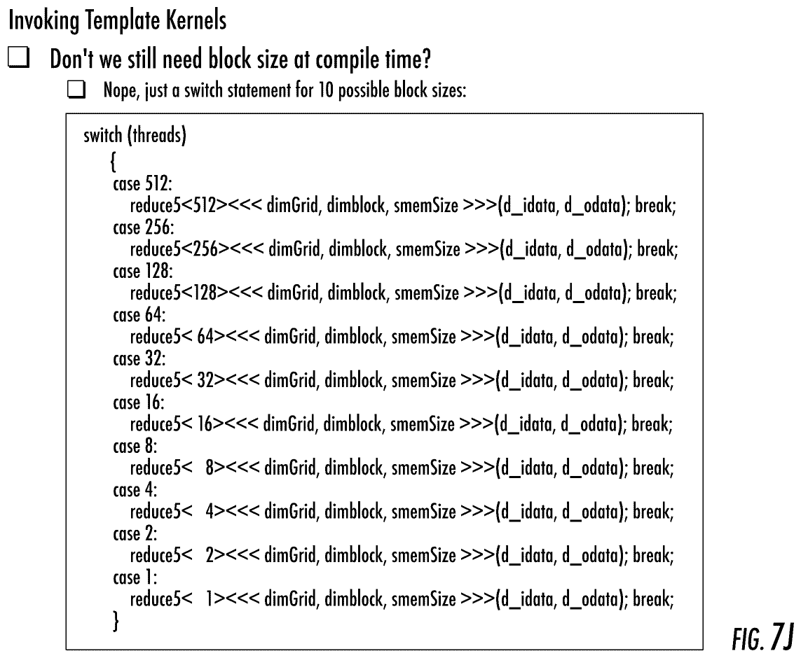

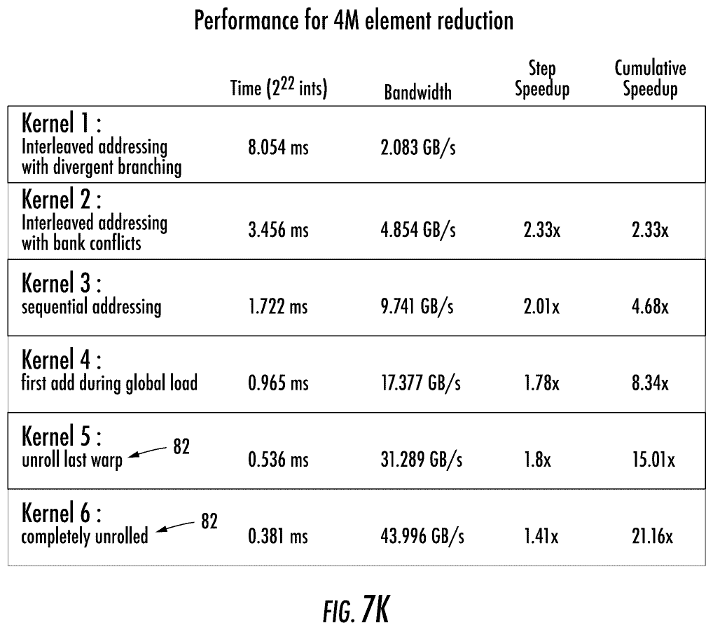

Referring generally to the figures and more specifically to FIGS. 7A to 7I, the instruction bottleneck 78 is illustrated. In the present system and method, an instruction bottleneck 78 is an ancillary instruction that is not a load, store or arithmetic for core computation and is usually address arithmetic and loop overhead. These instructions typically slow down computation speed. In the present system, the loops 80 are unrolled 82. Unrolling 82 is utilized when the active thread block count 14 is less than or equal to 32 threads. For this to be correct, the term “volatile” should be used in the control string 84. Without unrolling 82, all warps execute every iteration of the for loop and if statement. FIG. 7D illustrates the speed increase when the last warp loop 80 is unrolled 82. As shown in Kernel 5, when the last warp is unrolled, the speed of the calculation is increased. It is also possible to have complete unrolling 82 to add additional speed. If the number of iterations is known at compile time, the reduction can be completely unrolled. As a known parameter, the block size is limited by the GPU to 512 threads and the present system typically utilizes two blocks. However, the block sizes may not be known at compiling time, thus the present system utilizes a template 86 which may be created using C++, which is supported by CUDA. FIG. 7G illustrates one manner of specifying a block size as a function of a template 86 parameter. As illustrated in FIG. 7H-7I, all code can be evaluated at compile time, resulting in an efficient inner loop. As illustrated on FIG. 7J, by providing a switch statement 88, we don't need the block size at compiling. FIG. 7K illustrates the computing time difference when completely unrolled in Kernel 6, which shows that the time improvement thus far is over 21 times as fast and efficient as interleaved addressing with divergent branching.

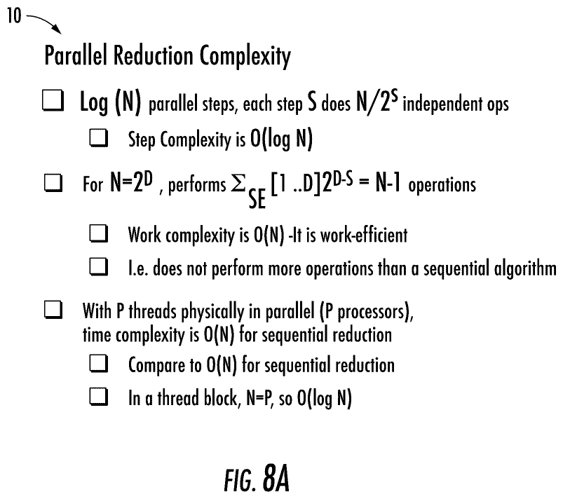

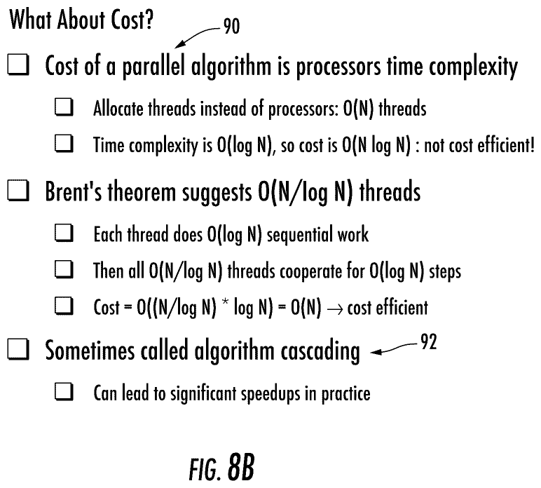

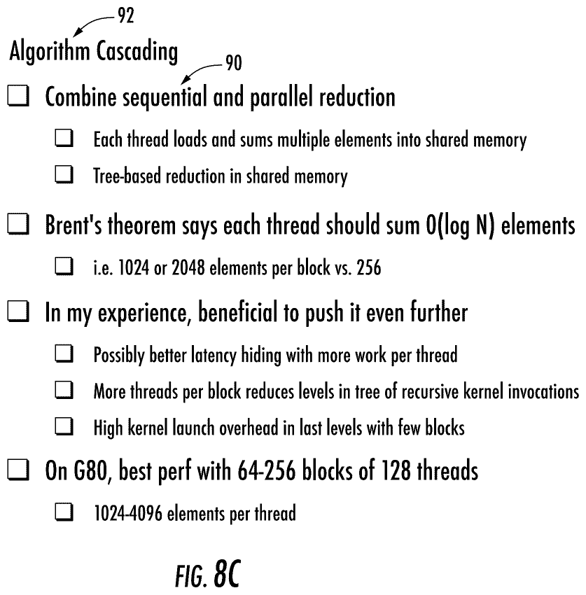

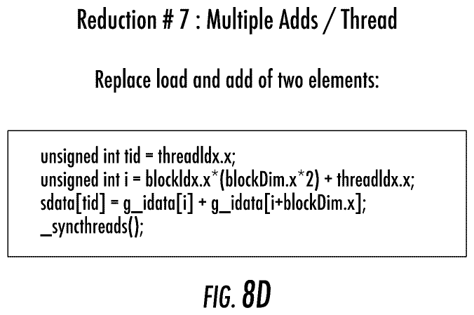

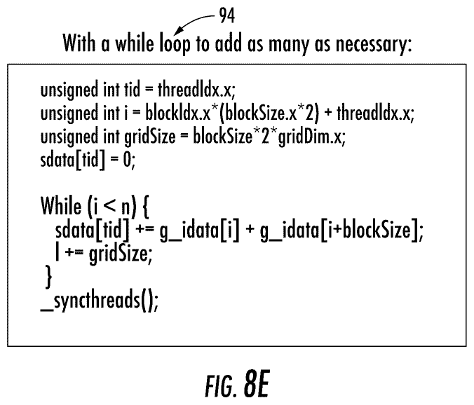

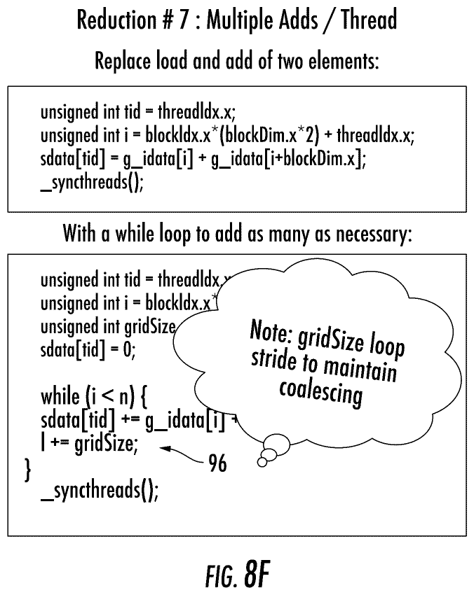

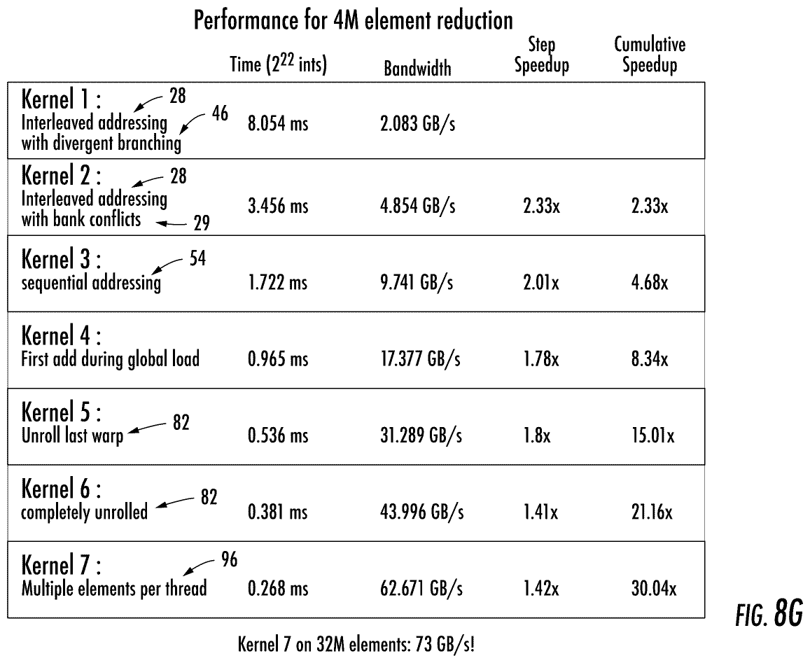

Referring generally to the figures, and more specifically to FIGS. 8A-8G, where various versions of parallel reduction 10 are illustrated. Parallel reduction algorithm speed increases are generally processors, time and complexity. It is presently suggested that algorithm cascading 92 can lead to significant speed increases. In this method, sequential and parallel reduction is combined and placed in shared memory. On a G80 processor, it has been found that the best performance is achieved with 64-256 blocks of 128 threads and 1024 to 4096 elements per thread. FIG. 8D illustrates the code necessary to replace load and add two elements. A while loop 94 is utilized to add as many as necessary in FIG. 8E. FIG. 8F illustrates the speed change when multiple elements per thread are utilized. Kernel 7 specifically shows the improved times provided by using this method.

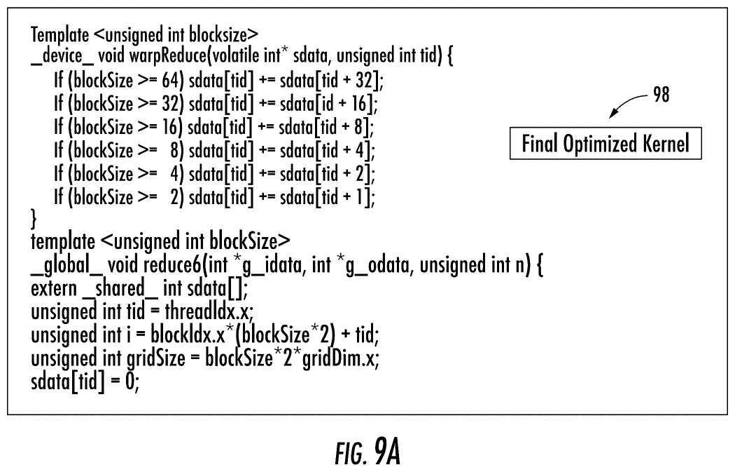

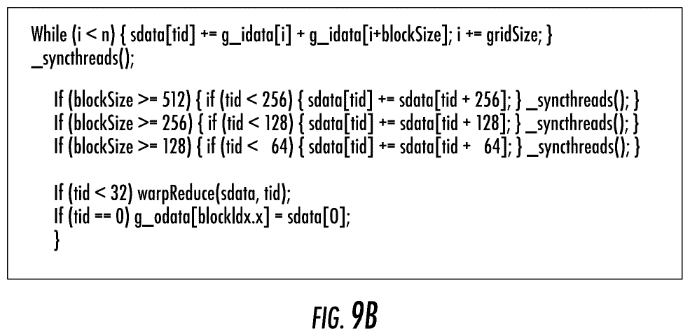

Still referring generally to the figures, and more specifically to FIGS. 9A-9B, the final optimized Kernel 98 is addressed. In these figures, code for reducing the computation speed of the final Kernel 98 is illustrated.

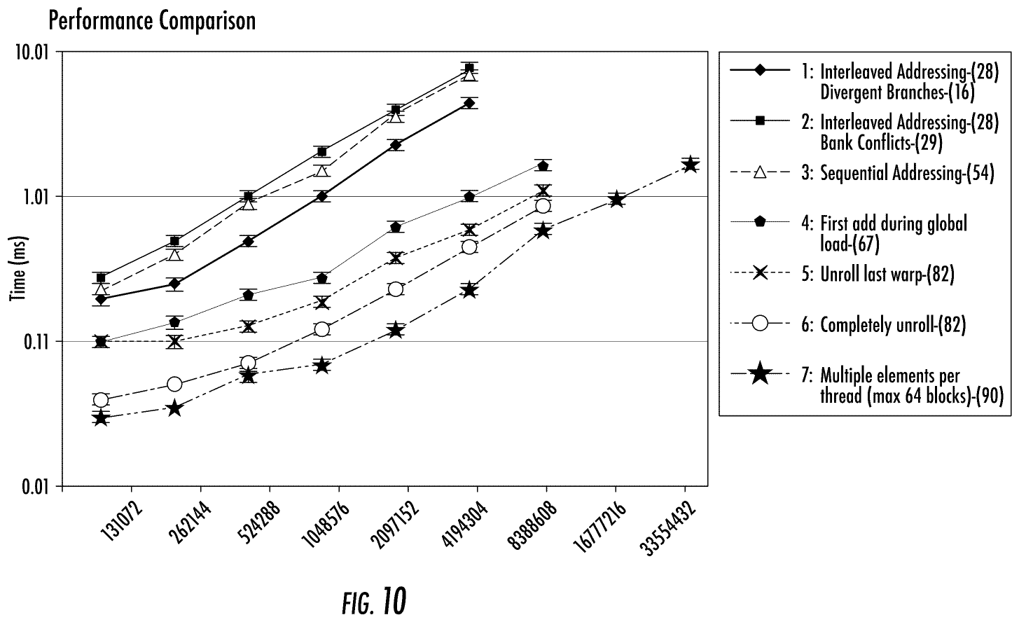

Still referring generally to the figures, and more specifically to FIG. 10, a performance comparison of the seven factors outlined in this paper are illustrated.
1 All patents and publications mentioned in this specification are indicative of the levels of those skilled in the art to which the invention pertains. All patents and publications are herein incorporated by reference to the same extent as if each individual publication was specifically and individually indicated to be incorporated by reference.
1 It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.
1 One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A software (100) for improving the speed of computations performed by a computer having a monitor, a keyboard, a pointer, hard memory, temporary memory, virtual memory, random access memory and at least one central processing unit (CPU) (15) comprising;
the software (100) first analyzes the type of CPU (15), the software then determines a maximum random access memory (RAM) size, the software then determines the maximum number of memory channels and the maximum memory bandwidth provided by the hardware, next the software determines what the maximum CPU operating temperature is, the software determines whether there is a deep learning boost available on the CPU, how many cores there are in the CPU, if high priority cores are available, and what frequency the high priority cores are verses the number of low priority cores available in the CPU (15) and the availability of a CPU cache (19),
wherein the software (100) analyzes the computer hardware components particularly with respect to the CPU (15) and modifies the software steps and sequences to improve the calculation speed of data passing through the computer system by modifying the calculation steps to conform to the computer hardware construction.

2. The software (100) for improving the speed of computer computations of claim 1 wherein after modifying the software (100) to better utilize the computer hardware, the software causes the data to be calculated to be decomposed into multiple kernels (20) to serve as a global synchronization point.

3. The software (100) for improving the speed of computer computations of claim 2 wherein recursive kernel invocation (22) can be utilized to process the data.

4. The software (100) for improving the speed of computer computations of claim 3 wherein a GFLOP(s) is/are utilized for compute-bound kernels (24) and a bandwidth is utilized for memory-bound kernels (26).

5. The software (100) for improving the speed of computer computations of claim 4 wherein the data is separated into thread blocks (14) for further processing.

6. The software (100) for improving the speed of computer computations of claim 5 wherein the software (100) includes an interleaved addressing (28) command wherein each thread block (14) loads one element from global memory (38) to shared memory (34) providing a reduction in shared memory, wherein the thread blocks are synced before the result is written to global memory (38).

7. The software (100) for improving the speed of computer computations of claim 5 wherein the software (100) further utilizes divergent branching (46) with the interleaved addressing, wherein the divergent branch is replaced in an inner loop with a strided index (50) and the non-divergent branch (52).

8. The software (100) for improving the speed of computer computations of claim 7 wherein the software (100) utilizes parallel reduction (10) with sequential addressing (54), wherein the sequential addressing (54) is accomplished by replacing the strided indexing (50) in the inner loop.

9. The software (100) for improving the speed of computer computations of claim 5 wherein the thread blocks (14) are loaded as two loads and a first add of the reduction reading from global memory (38) for writing to shared memory (34) to synchronize the thread blocks (14).

10. The software (100) for improving the speed of computer computations of claim 5 wherein the software (100) utilizes unrolling (82) when the thread (14) count is less than or equal to 32 threads.

11. The software (100) for improving the speed of computer computations of claim 10 wherein the number of iterations is known at compile time, allowing up to 512 threads (14) to be unrolled.

12. The software (100) for improving the speed of computer computations of claim 8 wherein the parallel reduction (10) is combined with sequential reduction to form algorithm cascading (92) wherein the data is combined and placed in shared memory (32).

13. The software (100) for improving the speed of computer computations of claim 1 wherein there is more than one central processing unit (15).

14. The software (100) for improving the speed of computer computations of claim 13 wherein the at least one central processing unit (15) includes at least one ultra path interconnect (UPI) for scaling multiprocessor systems with a shared address space.

15. The software (100) for improving the speed of computer computations of claim 14 wherein each processor includes at least three ultra path interconnects.
